(19) United States
(12) Patent Application Publication
(10) Pub. No.: US 2014/0344433 A1
(43) Pub. Date: Nov. 20, 2014

(54) NETWORK DESIGN APPARATUS AND NETWORK DESIGN METHOD

(71) Applicant: FUJITSU LIMITED, Kawasaki-shi (JP)

(72) Inventors: Yutaka Takita, Kawasaki (JP); Tomohiro Hashiguchi, Inagi (JP); Kazuyuki Tajima, Yokosuka (JP)

(73) Assignee: FUJITSU LIMITED, Kawasaki-shi (JP)

(21) Appl. No.: 14/230,820

(22) Filed: Mar. 31, 2014

(30) Foreign Application Priority Data
May 17, 2013 (JP) 2013-105574

(51) Int. Cl. H04L 12/24

(52) U.S. Cl. CPC H04L 41/145
USPC 709/223

(57) ABSTRACT

A network design apparatus includes: a memory; and a processor coupled to the memory. The processor executes a process including: calculating an allocation pattern not requiring cancellation of a connection request from among a plurality of allocation candidates, when the connection request transmitted/received between nodes on a network is to be allocated to a slot that constructs a link on the network; determining a change procedure of the connection request in order to change an allocation pattern provided before the network is re-optimized to the allocation pattern calculated at the calculating; and outputting the allocation pattern calculated at the calculating as an allocation pattern after the network is re-optimized, along with the change procedure determined at the determining.

### CROSS-REFERENCE TO RELATED APPLICATION

This application is based upon and claims the benefit of priority of the prior Japanese Patent Application No. 2013-105574, filed on May 17, 2013, the entire contents of which are incorporated herein by reference.

### FIELD

The embodiments discussed herein are related to a network design apparatus and a network design method.

### BACKGROUND

An optical network adopting a WDM (Wavelength Division Multiplex) system in the related art is designed to make the most of a resource (such as a bandwidth of an optical line) at the start of operation. As time passes, however, the network usually experiences a situation where the resource is not used to the fullest due to the change in distribution of a demand from a client, the change in network topology, or equipment failure, for example. Under such situation, it is effective for a network design apparatus to re-optimize the network by redesigning the network that is once optimized.

The network design apparatus in the attempt to re-optimize the network allocates the demand to each time slot (hereinafter simply referred to as a “slot”) of the optical line in a way different from the previous way. There is a possibility that the allocation causes communication interruption in the network in operation when the allocation of the demand to the slot is cancelled (hereinafter referred to as “demand cancellation” as needed) without preparing a substitute optical line in advance. Being a factor of interrupting a service provided by a telecommunications carrier, the communication interruption is desirably avoided as much as possible.

Patent Document 1: Japanese Laid-open Patent Publication No. 2012-199644

However, the aforementioned network design has had a problem as follows. That is, the network design apparatus in the related art has performed the allocation to the slot without considering the procedure of changing each demand in re-optimizing the network. The network design apparatus has therefore been unable to derive a procedure by which the network can be re-optimized without performing the demand cancellation (hereinafter referred to as a “best procedure”) in a short period of time when such procedure is available. Moreover, the network design apparatus has been unable to derive, in a short period of time, a procedure by which the network can be re-optimized with the smallest number of demand cancellations (hereinafter referred to as a “second best procedure”) when the best procedure is not available. These have been the factors of inhibiting the procedure that is effective in efficiently re-optimizing the network from being promptly presented to a user.

### SUMMARY

According to an aspect of the embodiments, a network design apparatus includes: a memory; and a processor coupled to the memory. The processor executes a process including: calculating an allocation pattern not requiring cancellation of a connection request from among a plurality of allocation candidates, when the connection request transmitted/received between nodes on a network is to be allocated to a slot that constructs a link on the network; determining a change procedure of the connection request in order to change an allocation pattern provided before the network is re-optimized to the allocation pattern calculated at the calculating; and outputting the allocation pattern calculated at the calculating as an allocation pattern after the network is re-optimized, along with the change procedure determined at the determining.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a configuration of a network design system;

FIG. 2 is a diagram illustrating a functional configuration of a network design apparatus;

FIG. 3 is a diagram illustrating a hardware configuration of the network design apparatus;

FIG. 4A is a diagram illustrating a configuration of a network before being re-optimized;

FIG. 4B is a diagram illustrating a configuration of the network after being re-optimized;

FIG. 5 is a diagram illustrating an allocation pattern of a demand to a slot;

FIG. 6A is a diagram used to describe a first half of how a change procedure of the demand changes in accordance with the allocation pattern of the demand after re-optimization;

FIG. 6B is a diagram illustrating a demand change procedure to perform the re-optimization when the best design is available;

FIG. 7A is a diagram used to describe a second half of how the change procedure of the demand changes in accordance with the allocation pattern of the demand after the re-optimization;

FIG. 7B is a diagram illustrating the demand change procedure to perform the re-optimization when the best design is unavailable;

FIG. 8 is a diagram illustrating a demand dependency graph representing demand dependency before and after the re-optimization;

FIG. 9A is a diagram illustrating a slot allocation pattern, for which the best design can be implemented, before and after the re-optimization;

FIG. 9B is a diagram illustrating how the demand dependency graph is created based on the slot allocation pattern for which the best design can be implemented;

FIG. 9C is a diagram illustrating the demand dependency graph created based on the slot allocation pattern for which the best design can be implemented;

FIG. 10A is a diagram illustrating the slot allocation pattern, for which the best design cannot be implemented, before and after the re-optimization;

FIG. 10B is a diagram illustrating how the demand dependency graph is created based on the slot allocation pattern for which the best design cannot be implemented;

FIG. 10C is a diagram illustrating the demand dependency graph created based on the slot allocation pattern for which the best design cannot be implemented;

FIG. 11 is a flowchart used to describe a slot allocation process considering the demand change procedure;

FIG. 12 is a diagram illustrating how a different optical line is classified into a group connected by the same physical link;

FIG. 13A is a diagram illustrating a state of the demand having a fixed slot before the re-optimization;

FIG. 13B is a diagram illustrating a state of the demand having the fixed slot after the re-optimization;

FIG. 14A is a diagram illustrating the demand when an AHC variable has a solution;

FIG. 14B is a diagram illustrating the demand when the AHC variable does not have a solution;

FIG. 15 is a diagram illustrating a list of parameters of a calculation model used in finding the allocation pattern of the demand to the slot;

FIG. 16A is a diagram illustrating the demand that does not require a process of easing a constraint which fixes the slot being used;

FIG. 16B is a diagram illustrating the demand that requires the process of easing the constraint which fixes the slot being used;

FIG. 17 is a diagram illustrating whether or not cancellation is feasible according to a type of the demand;

FIG. 18A is a diagram used to describe the number of demands involved in the slot allocation out of the total number of demands;

FIG. 18B is a diagram used to describe a method of allocating the demand involved in the slot allocation;

FIG. 19 is a diagram illustrating how an optimal solution for the demand change can be obtained by single calculation; and

FIG. 20 is a diagram used to describe an effect of reducing a calculation load accompanying the calculation of an allocation result and the change procedure.

### DESCRIPTION OF EMBODIMENTS

Preferred embodiments will be explained with reference to accompanying drawings. Note that the network design apparatus and the network design method are not to be limited by the following embodiments.

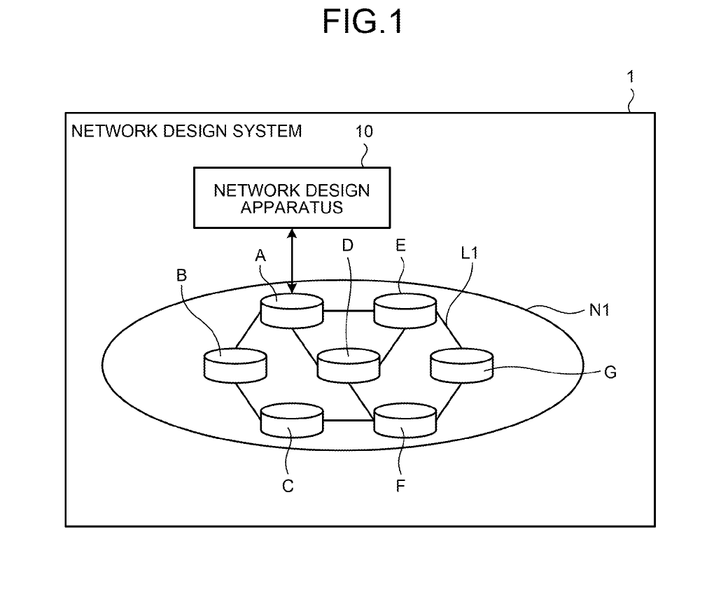

A configuration of a network design system according to an embodiment disclosed in the application will be described first. FIG. 1 is a diagram illustrating the configuration of a network design system 1. As illustrated in FIG. 1, the network design system 1 includes a network N1 and a network design apparatus 10 connected on the network N1. A plurality of nodes A to G is arranged on the network N1 where each of the nodes A to G is connected by an optical line link L1. While FIG. 1 illustrates the configuration where the network design apparatus 10 is connected to the node A from among the plurality of nodes A to G, the network design apparatus 10 may be connected to another node including the nodes B to G as well.

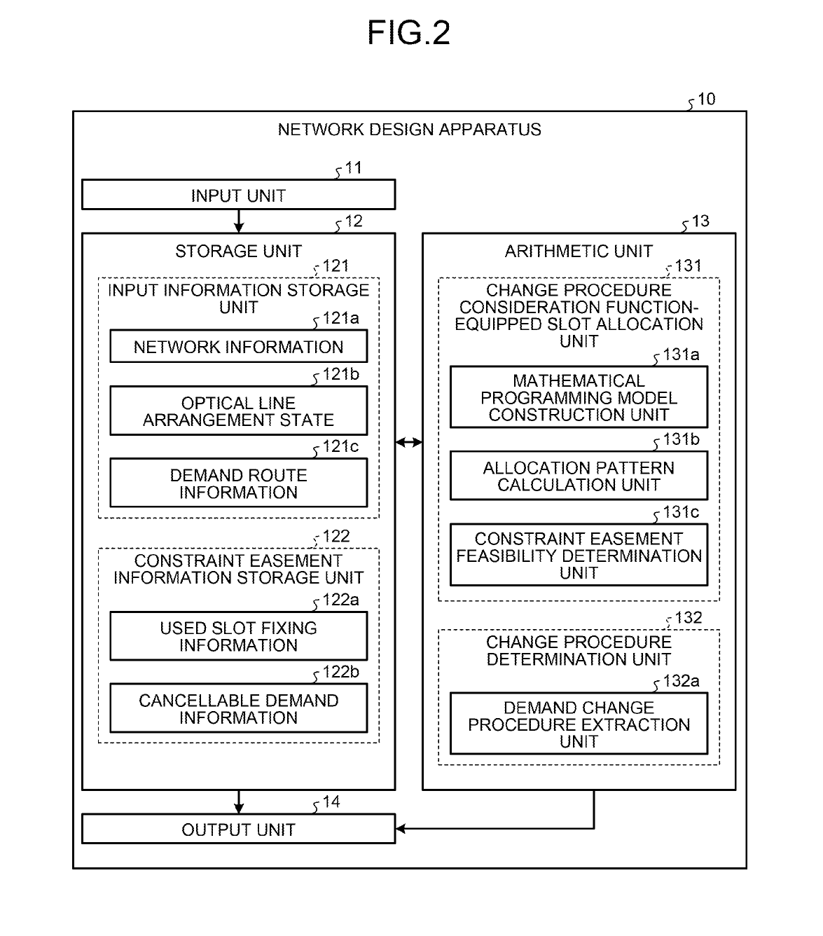

FIG. 2 is a diagram illustrating a functional configuration of the network design apparatus 10. As illustrated in FIG. 2, the network design apparatus 10 includes an input unit 11, a storage unit 12, an arithmetic unit 13, and an output unit 14. Each of these components is connected to be able to input/output a signal and/or data in one way or two ways.

The input unit 11 inputs, as information related to the network N1 to be designed, a location of a station, the presence of fiber connection between the stations, and which demand corresponding to a bandwidth of what extent is present from which station to which station, for example. The input unit 11 further inputs information pertaining to a demand generated in the network N1 and an arrangement state of the optical line link L1 before and after performing re-optimization designing, for example. Specifically, the input unit 11 inputs information such as the arrangement of the optical line within the network N1 or how the demand is accommodated in the optical line, before and after the re-optimization.

The storage unit 12 includes an input information storage unit 121 and a constraint easement information storage unit 122. The input information storage unit 121 stores the various pieces of information input by the input unit 11. The constraint easement information storage unit 122 stores information on a site (such as between the nodes A and B) subjected to a constraint to fix a slot to be used when performing preprocessing of the network design. The constraint easement information storage unit 122 further stores information on a demand (such as a demand D1), the cancellation of which is permitted in a constraint easement process.

The arithmetic unit 13 includes a change procedure consideration function-equipped slot allocation unit 131 and a change procedure determination unit 132. The change procedure consideration function-equipped slot allocation unit 131 further includes a mathematical programming model construction unit 131a, an allocation pattern calculation unit 131b, and a constraint easement feasibility determination unit 131c. The mathematical programming model construction unit 131a constructs, based on the information stored in the storage unit 12, a mathematical programming model that can be represented by using a variety of parameters to be described later. The allocation pattern calculation unit 131b calculates an optimal slot allocation pattern by using the mathematical programming model constructed by the mathematical programming model construction unit 131a. The constraint easement feasibility determination unit 131c determines whether or not the constraint easement process can be applied in each station within the network N1 from the result of calculation performed by the allocation pattern calculation unit 131b, and at the same time updates the information within the constraint easement information storage unit 122 based on the determination result.

The change procedure determination unit 132 determines a demand change procedure based on the result of slot allocation performed by the change procedure consideration function-equipped slot allocation unit 131. Specifically, the change procedure determination unit 132 extracts the demand change procedure from the slot allocation result obtained by executing the mathematical programming model and outputs the procedure to the output unit 14.

Based on the calculation result by the allocation pattern calculation unit 131b, the output unit 14 outputs information of the demand that requires cancellation and information of the slot formed on the optical line link L1 in which the demand is accommodated. The output unit 14 further outputs the demand change procedure extracted by the change procedure determination unit 132.

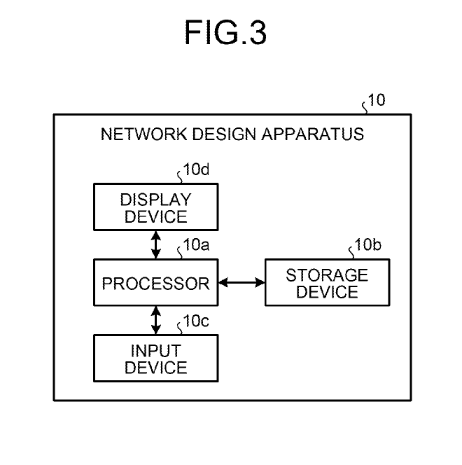

Now, a hardware configuration of the network design apparatus 10 will be described. FIG. 3 is a diagram illustrating the hardware configuration of the network design apparatus 10. In the network design apparatus 10 as illustrated in FIG. 3, a processor 10a, a storage device 10b, an input device 10c, and a display device 10d are connected to be able to input/output various signals and/or data through a bus. The processor 10a is a CPU (Central Processing Unit) or a DSP (Digital Signal Processor), for example. The storage device 10b includes a non-volatile storage device such as an HD (Hard Disk), a ROM (Read Only Memory), and a flash memory as well as a RAM such as an SDRAM (Synchronous Dynamic Random Access Memory). The input device 10c is formed of a keyboard, a mouse, or a touch panel, for example, while the display device 10d is formed of an LCD (Liquid Crystal Display) or an ELD (Electro Luminescence Display), for example.

With regard to the correspondence between the functional configuration and the hardware configuration, the input unit 11 among the functional components of the network design apparatus 10 illustrated in FIG. 2 is realized by the input device 10c as hardware. The storage unit 12 is realized by the storage device 10b, and the arithmetic unit 13 is realized by the processor 10a and the storage device 10b. The output unit 14 is realized by the processor 10a and the display device 10d.

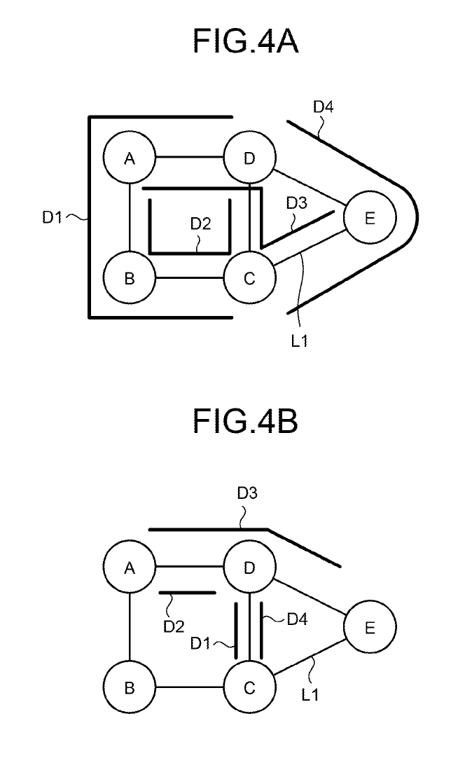

Next, an overview of a network re-optimization process will be described with reference to FIGS. 4A and 4B. FIG. 4A is a diagram illustrating a configuration of the network N1 before being re-optimized. The optical line link L1 illustrated in FIG. 4A is a 10-Gbps optical line in which eight slots can be allocated per span (between adjacent nodes). Each of demands D1 to D4 is a 5-Gbps connection request requiring four slots per span. In the network N1 before being re-optimized, the demand D1 connects between the nodes D and C via the nodes A and B, and the demand D2 connects between the nodes A and D via the nodes B and C, as illustrated in FIG. 4A. Likewise, the demand D3 connects between the nodes A and E via the nodes D and C, and the demand D4 connects between the nodes D and C via the node E. Accordingly, the resource to be used equals 11 spans×four slots.

On the other hand, FIG. 4B is a diagram illustrating the configuration of the network N1 after being re-optimized. As illustrated in FIG. 4B, the demand D1 is optimized to have a route directly connecting the nodes D and C, and the demand D2 is optimized to have a route directly connecting the nodes A and D. The demand D3 is optimized to have a route connecting between the nodes A and E via not the node C but only the node D. Moreover, the demand D4 is optimized to have a route directly connecting the nodes D and C. As a result, the resource to be used equals only five spans×four slots, which means that the resource to be used can be cut down by 24 (=44−20) resources as compared to pre-optimization.

What is important in the aforementioned re-optimization is the change procedure of the network configuration, namely, the route to realize the demand from the client. While the network design apparatus 10 can free the slot of the optical line in use by performing the demand cancellation, it is desired that the demand cancellation be avoided as much as possible in terms of securing operation reliability. Therefore, the change procedure with no demand cancellation can be defined as a “best design”, whereas the change procedure with the minimum number of demand cancellations can be defined as a “second best design”. It is further desired that the number of changes of the demand be kept to the minimum as much as possible.

The change of demand is implemented by a switching function at each station only when there exists a vacant slot in the optical line link L1. In a case of an OTN (Optical Transport Network), for example, the change of the demands D1 to D4 can be implemented by utilizing an ODU (Optical Data Unit)−XC (cross Connect) function.

Here, a demand allocation pattern (slot allocation pattern) will be described as a precondition to the change procedure of the demand. The allocation pattern of the optical line link L1 configuring the network N1 is already determined in the present embodiment where it is assumed that the network N1 is optimized once. Accordingly, what becomes important is how the network design apparatus 10 designs the allocation pattern after re-optimization.

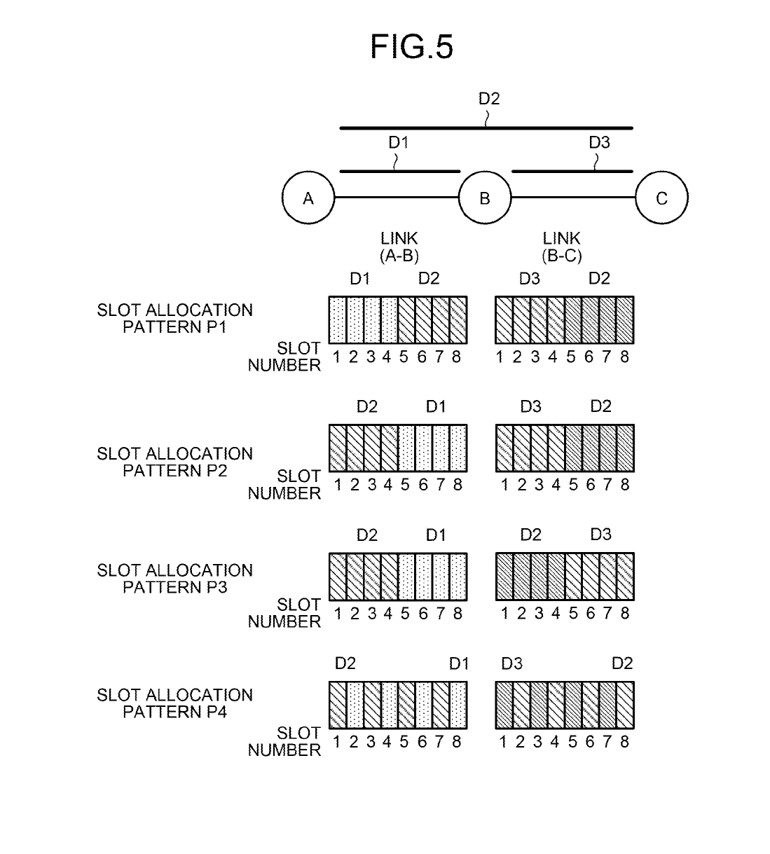

FIG. 5 is a diagram illustrating the demand allocation pattern to the slot. As illustrated in FIG. 5, the optical line link L1 has eight slots per internode, whereas the demand occupies four slots per internode. This means that only two types of demands (such as the demand D1 and the demand D2) are allocated at most in a single internode (eight slots) on the optical line link L1. FIG. 5 illustrates the example where the demands D1 and D2 are allocated in the slots between the nodes A and B, while the demands D2 and D3 are allocated in the slots between the nodes B and C. In this case, however, the demand can be allocated in each of links A-B and B-C in innumerable ways including at least four slot allocation patterns P1 to P4 illustrated in FIG. 5. The change procedure the demand varies according to the slot allocation pattern.

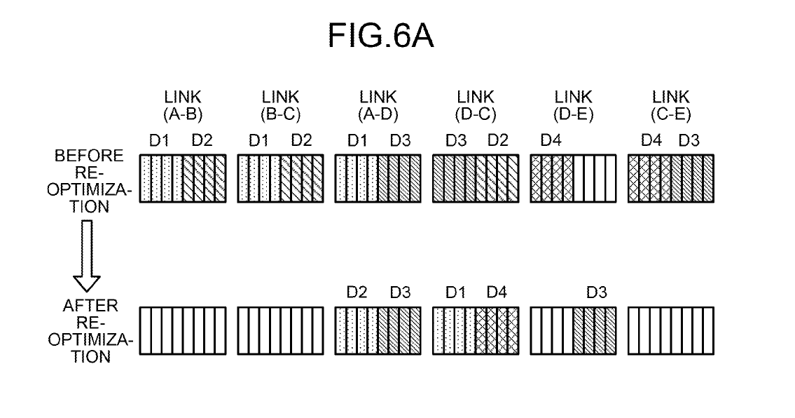

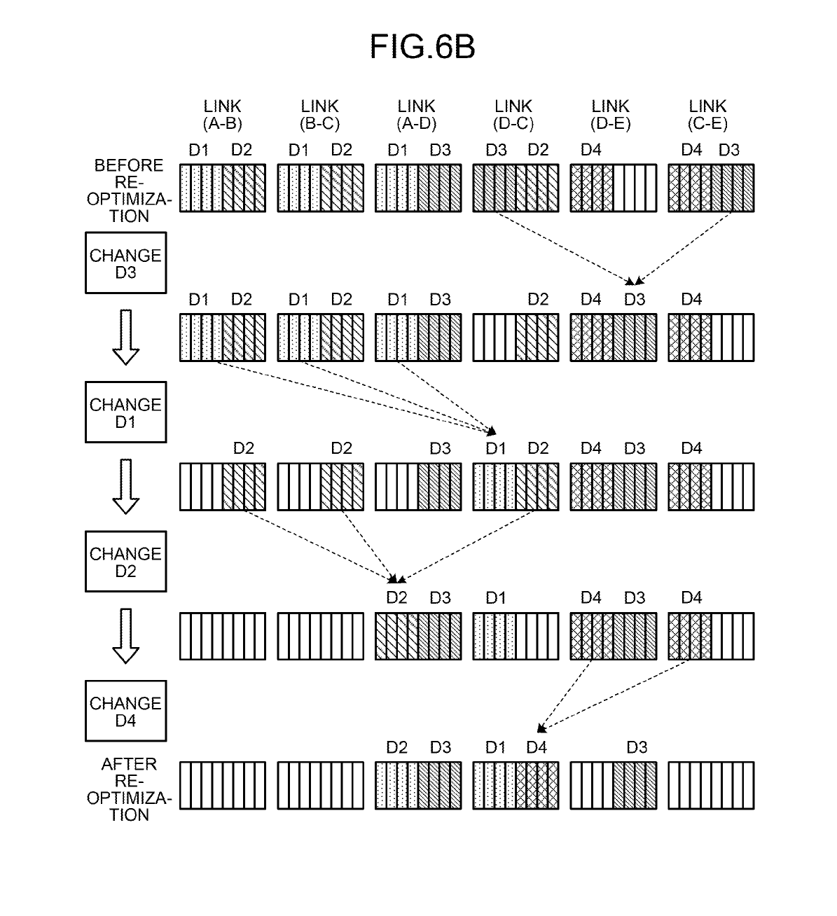

FIG. 6A is a diagram used to describe a first half of how the change procedure of the demand changes in accordance with the allocation pattern (allocation result) of the demand after re-optimization. As illustrated in FIG. 6A, there is assumed a case where the demands D2 and D3, D1 and D4, and D3 are allocated in links A-D, D-C, and D-E, respectively, as the allocation pattern after re-optimization. FIG. 6B is a diagram illustrating the demand change procedure to perform the re-optimization when the best design is available. As illustrated in FIG. 6B, the network design apparatus 10 can perform the re-optimization without cancelling any demands by changing the slot to which each of the demands D3, D1, D2, and D4 is allocated in this order from the allocation pattern before the re-optimization. In other words, the network design apparatus 10 can realize the best design of the network N1.

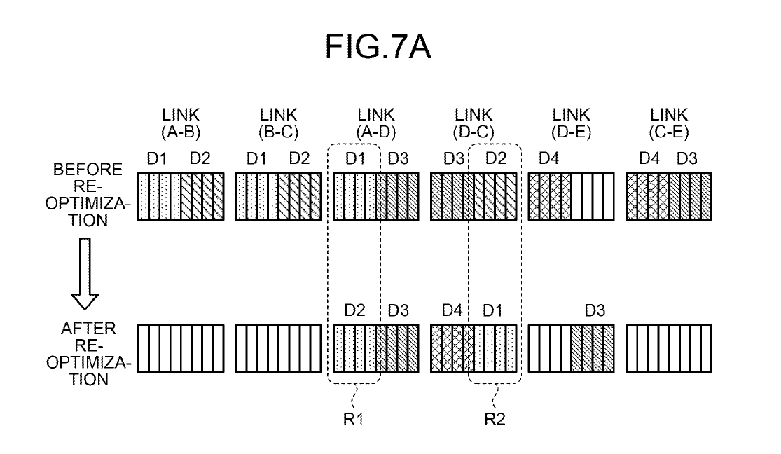

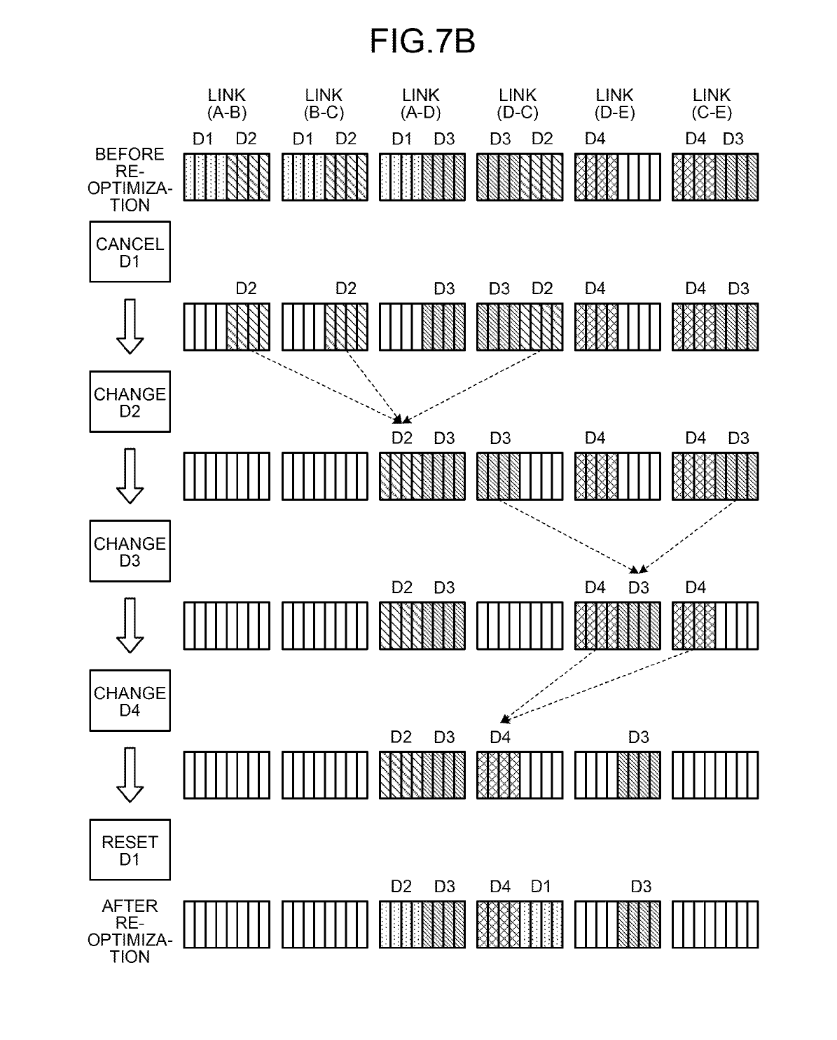

On the other hand, FIG. 7A is a diagram used to describe a second half of how the demand change procedure changes in accordance with the allocation pattern (allocation result) of the demand after the re-optimization. As illustrated in FIG. 7A, there is assumed a case where the demands D2 and D3, D4 and D1, and D3 are allocated in the links A-D, D-C, and D-E, respectively, as the allocation pattern after the re-optimization. Unlike FIG. 6A, FIG. 7A illustrates a state (a deadlock state) where the demand D2 needs to be moved before moving the demand D1 and the demand D1 needs to be moved before moving the demand D2 in regions R1 and R2 each enclosed with a broken line, respectively. This means that at least either one of the demands D1 and D2 needs to be cancelled in order for the slot allocation pattern to be in the state after the re-optimization.

FIG. 7B is a diagram illustrating the demand change procedure to perform the re-optimization when the best design is unavailable. As illustrated in FIG. 7B, the network design apparatus 10 starts from the allocation pattern before the re-optimization, cancels the demand D1 temporarily, and then changes the slot to which each of the demands D2, D3, and D4 is allocated in this order. The network design apparatus 10 thereafter resets the cancelled demand D1 to be able to perform the re-optimization while keeping the number of demand cancellations to the minimum (one). In other words, the network design apparatus 10 can realize the second best design of the network N1. As described above, the difference in the demand allocation patterns to the slot (refer to FIGS. 6A and 7A) affects the change procedure of the demand, where the change procedure varies greatly according to the demand allocation pattern. It is therefore important for the network design apparatus 10 to consider the change procedure of the demand in the determination of the demand allocation pattern when performing the re-optimization of the network N1.

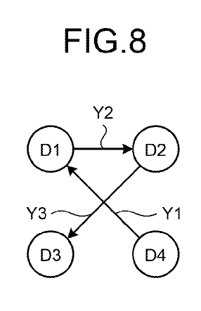

Now, there will be described a demand dependency graph that is an effective tool to find out the aptitude of the change procedure. FIG. 8 is a diagram illustrating the demand dependency graph representing demand dependency before and after the re-optimization. As illustrated in FIG. 8, the demand dependency graph is a digraph in which the optical line link L1 has a direction. In FIG. 8, an arrow Y1 is drawn from the demand D4 as a starting point toward the demand D1. One can tell from this that the slot used by the demand D1 is to be used by the demand D4 after the re-optimization. Likewise, one can tell from arrows Y2 and Y3 that the slot used by each of the demands D2 and D3 is to be used by the demands D1 and D2 after the re-optimization, respectively. The demand dependency graph is created while considering the dependency between the demands for each slot, as described above.

The network design apparatus 10 can determine the feasibility of the network design as follows by referring to the demand dependency graph. The best design illustrated in FIG. 6A is feasible when the demand dependency graph does not include a loop, for example. On the other hand, the second best design is feasible when the demand dependency graph includes a loop but there is at least one demand (such as the demands D1 and D2) that can be cancelled among the plurality of demands configuring the loop. However, the network design apparatus 10 can realize neither the best design nor the second best design for the network N1 when there is no demand that can be cancelled on the loop.

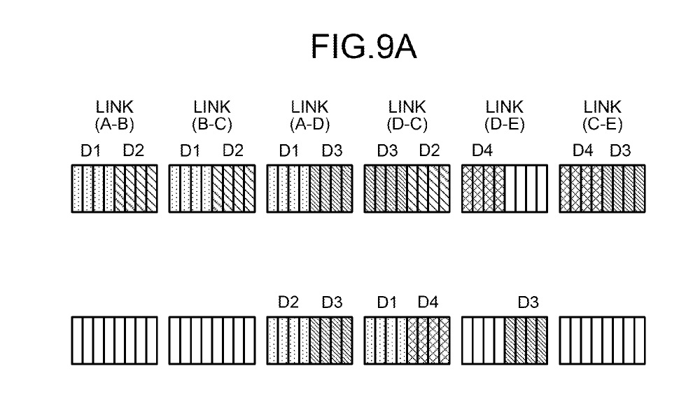

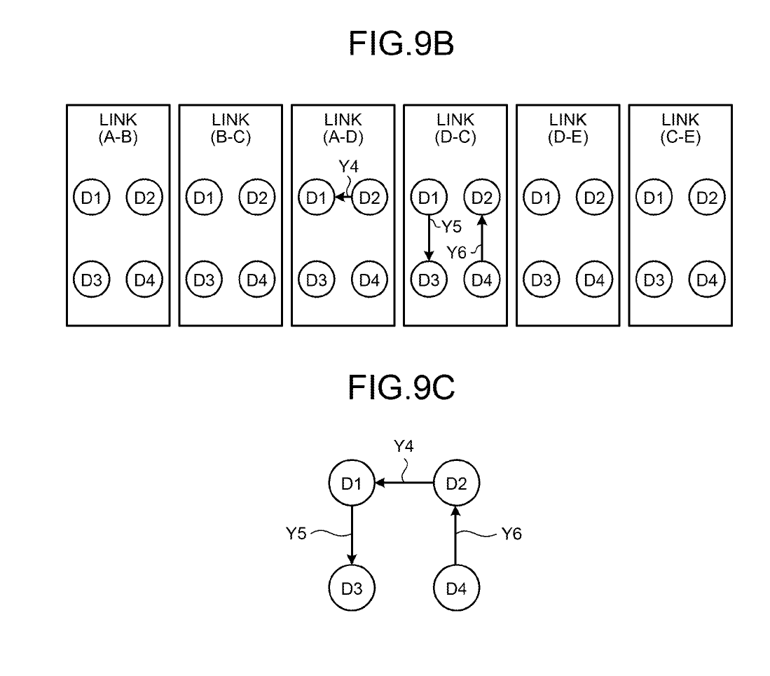

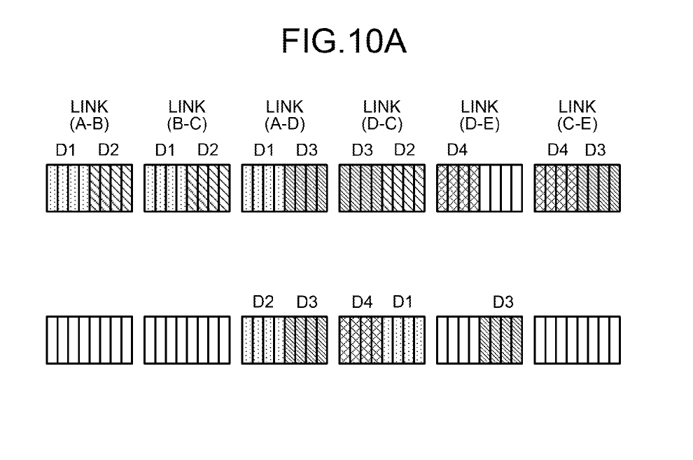

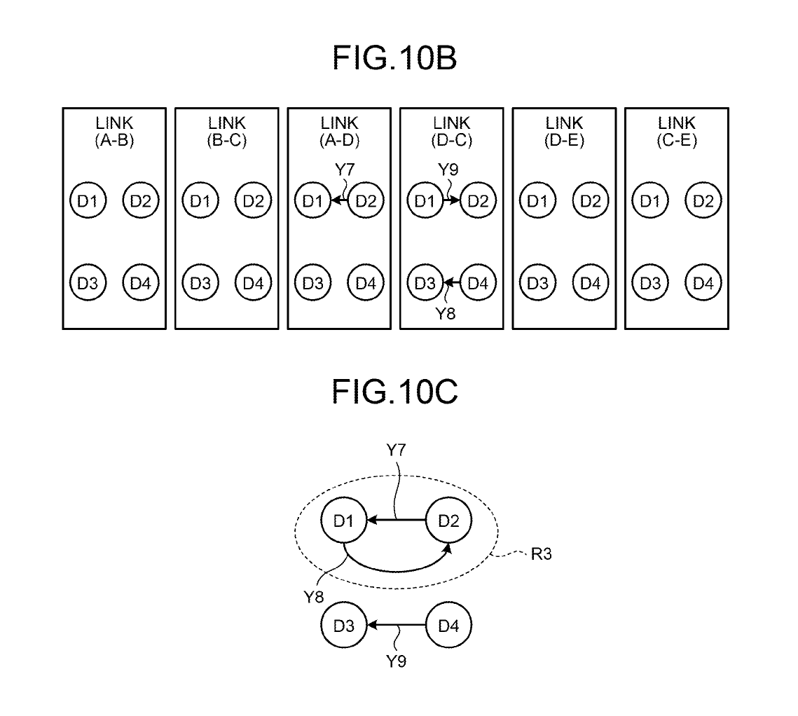

Next, a method of creating the demand dependency graph will be described with reference to FIGS. 9A to 10C. FIG. 9A is a diagram illustrating the slot allocation pattern, for which the best design can be implemented, before and after the re-optimization. Being similar to FIG. 6A, FIG. 9A will not be described in detail. FIG. 9B is a diagram illustrating how the demand dependency graph is created based on the slot allocation pattern for which the best design can be implemented. As illustrated in FIG. 9B, the demand dependency graph is created for each section of the optical line link L1 while considering the dependency among each of the demands D1 to D4.

For example, no arrow is drawn in the links A-B, B-C, D-E, and C-E where the demand allocation is not performed after the re-optimization, whereas the demand D1 is replaced by the demand D2 in the link A-D. Accordingly, an arrow Y4 is drawn from the demand D2 toward the demand D1 in the link A-D in FIG. 9B. Likewise, the demand D1 is replaced by the demand D3 as well as the demand D4 is replaced by the demand D2 in the link D-C. Accordingly, an arrow Y5 from the demand D3 toward the demand D1 as well as an arrow Y6 from the demand D2 toward the demand D4 are drawn in the link nodes D-C in FIG. 9B.

The demand dependency graph is created by putting together all the demand dependencies occurring in each section illustrated in FIG. 9B. FIG. 9C is a diagram illustrating the demand dependency graph created based on the slot allocation pattern for which the best design can be implemented. As illustrated in FIG. 9C, the created demand dependency graph does not include a loop, whereby it is determined that the best design can be implemented for the slot allocation pattern before and after the re-optimization (refer to FIG. 9A). In addition to the feasibility of the best design, the change procedure of the demand can also be specified from the demand dependency graph illustrated in FIG. 9C. That is, the network design apparatus 10 can acquire the change procedure of the demands D1 to D4 from the allocation pattern before the re-optimization to the allocation pattern after the re-optimization by tracing the arrows Y5, Y4, and Y6 illustrated in the demand dependency graph in a reverse direction.

FIG. 10A is a diagram illustrating the slot allocation pattern, for which the best design cannot be implemented, before and after the re-optimization. Being similar to FIG. 7A, FIG. 10A will not be described in detail. FIG. 10B is a diagram illustrating how the demand dependency graph is created based on the slot allocation pattern for which the best design cannot be implemented. As illustrated in FIG. 10B, the demand dependency graph is created for each section of the optical line link L1 while considering the dependency among each of the demands D1 to D4.

For example, no arrow is drawn in the links A-B, B-C, D-E, and C-E where the demand allocation is not performed after the re-optimization, whereas the demand D1 is replaced by the demand D2 in the link A-D. Accordingly, an arrow Y7 is drawn from the demand D2 toward the demand D1 in the link A-D in FIG. 10B. Likewise, the demand D3 is replaced by the demand D4 as well as the demand D2 is replaced by the demand D1 in the link D-C. Accordingly, an arrow Y8 from the demand D4 toward the demand D3 as well as an arrow Y9 from the demand D1 toward the demand D2 are drawn in the link D-C in FIG. 10B.

The demand dependency graph is created by putting together all the demand dependencies occurring in each section illustrated in FIG. 10B. FIG. 10C is a diagram illustrating the demand dependency graph created based on the slot allocation pattern for which the best design cannot be implemented. As illustrated in FIG. 10C, the created demand dependency graph includes a loop within a region R3 enclosed with a broken line. It can therefore be determined that the best design cannot be implemented for the slot allocation pattern before and after the re-optimization (refer to FIG. 10A). In addition to the feasibility of the best design, the demand to be cancelled can also be specified from the demand dependency graph illustrated in FIG. 10C. That is, the loop is formed of the arrows Y7 and Y8 illustrated in the demand dependency graph, whereby the network design apparatus 10 can re-optimize the network N1 by allowing either one of the demands D1 and D2 located at the edge of the loop to be cancelled.

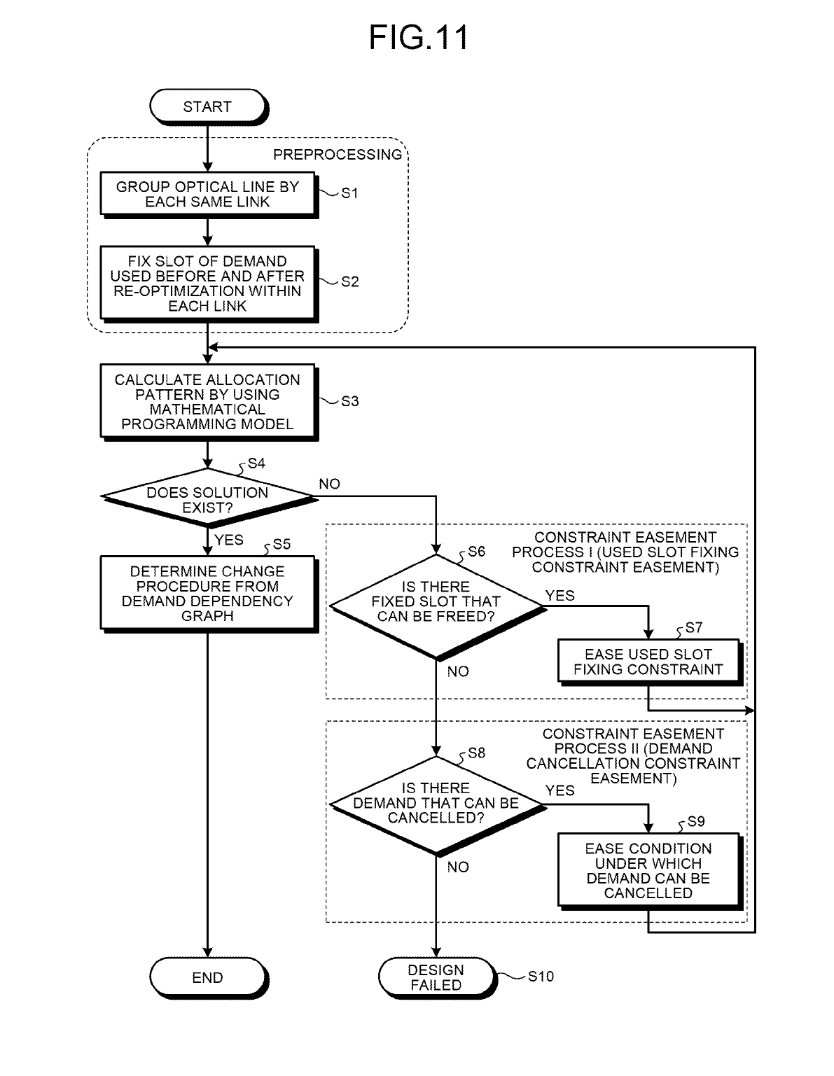

The operation will now be described. FIG. 11 is a flowchart used to describe a slot allocation process considering the demand change procedure.

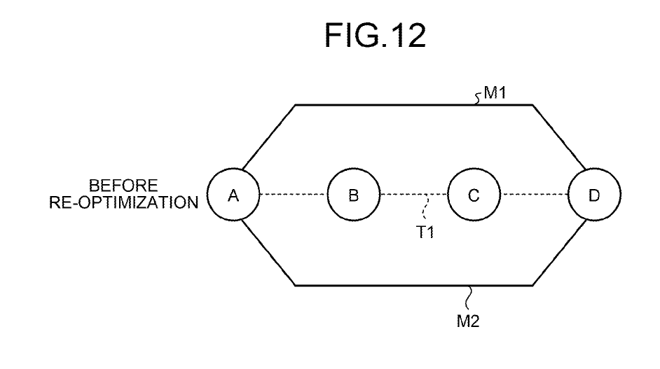

In S1, the mathematical programming model construction unit 131a divides the optical line into groups each having the same physical link, as a first half of preprocessing. FIG. 12 is a diagram illustrating how different optical line links M1 and M2 are classified into a group connected by the same physical link T1. As illustrated in FIG. 12, the optical line links M1 and M2 are mutually different links but connect the nodes A to D by the same physical link T1. The optical line link M1 and the optical line link M2 are thus classified as the optical line within the same group. In this manner, the mathematical programming model construction unit 131a executes the process of putting together the plurality of optical line links M1 and M2 corresponding to the same physical link T1 into one group.

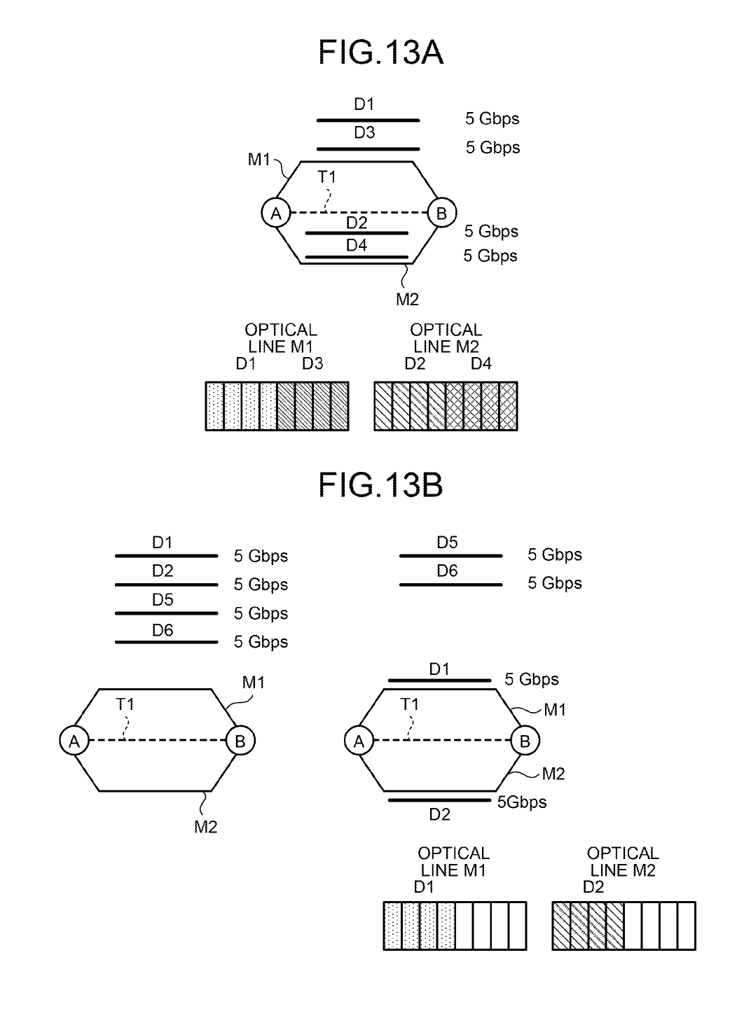

In S2, the mathematical programming model construction unit 131a fixes the slot of the demand used both before and after the re-optimization in each physical link, as a second half of the preprocessing. FIG. 13A is a diagram illustrating a state of the demands D1 and D2 each having the fixed slot before the re-optimization. FIG. 13B is a diagram illustrating a state of the demands D1 and D2 each having the fixed slot after the re-optimization. As illustrated in FIGS. 13A and 13B, the demands D1 and D2 out of the demands D1 to D4 are used in the same physical link T1 (within the same group) before and after the re-optimization. Accordingly, the mathematical programming model construction unit 131a fixes the slot used by each of the demands D1 and D2 to the slot on the left side of each of the optical line links M1 and M2. On the other hand, the slot of which of the optical line links M1 and M2 to be used to allocate demands D5 and D6 is not fixed, but is selected and determined by a network designer.

That is, in S2, the network design apparatus 10 applies a constraint to fix the slot to which the demand is allocated when the same demand (the demands D1 and D2 in the present embodiment) is accommodated in the same group both before and after the re-optimization. This constraint allows the network design apparatus 10 to greatly reduce the calculation load on a first round of calculation model and to obtain an optimal solution (optimal allocation pattern and change procedure) under most conditions. There is however a case where no solution is obtained as a result of the constraint depending on the allocation pattern before the re-optimization. The network design apparatus 10 in such case provides relief by easing the constraint in a process to be described later.

In S3, the mathematical programming model construction unit 131a of the network design apparatus 10 constructs a mathematical programming model that is a calculation model utilizing mathematical programming, and then the allocation pattern calculation unit 131b uses the model to calculate the demand allocation pattern to the slot. The network design apparatus 10 considers the demand change procedure when calculating the allocation pattern.

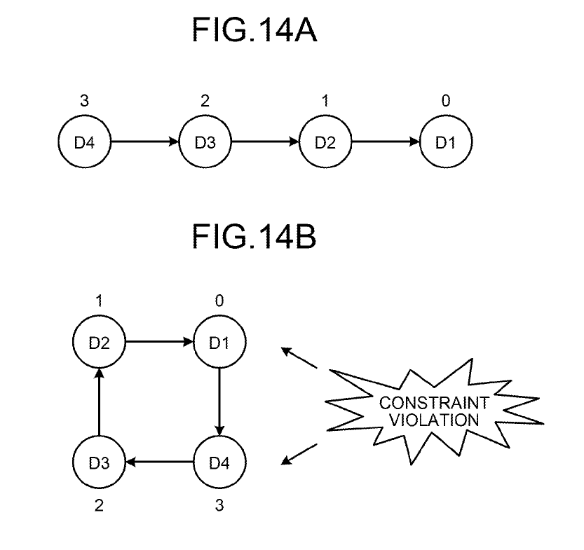

The mathematical programming model construction unit 131a constructs the mathematical programming model by using a parameter such as an AHC (Acyclic Hop Count) variable. The AHC variable is an integer value given to each of the demands D1 to D4 and is determined under the constraint that, in the aforementioned demand dependency graph, the demand on the upstream side has to have a value greater than that of the demand on the downstream side. FIG. 14A is a diagram illustrating the demand when the AHC variable has a solution. As illustrated in FIG. 14A, the AHC variable has a solution only when the demand dependency graph is an acyclic graph. The allocation pattern calculation unit 131b calculates the allocation pattern such that the AHC variable has a solution, namely, the allocation pattern where the demand dependency graph does not include a loop.

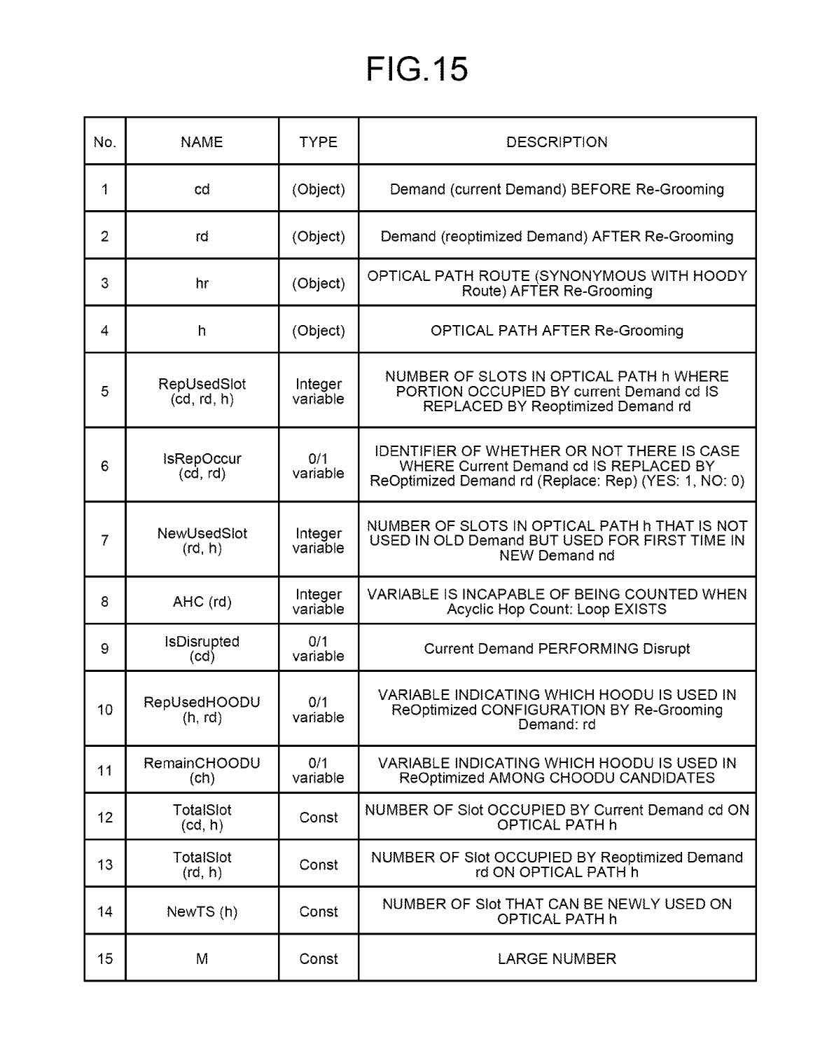

FIG. 14B is a diagram illustrating the demand when the AHC variable does not have a solution. As illustrated in FIG. 14B, the AHC variable does not have a solution when the demand dependency graph is a cyclic graph (a graph including a loop). FIG. 15 is a diagram illustrating a list of parameters of the calculation model used in finding the demand allocation pattern to the slot. The network design apparatus 10 uses the AHC variable and the parameter illustrated in FIG. 15 to calculate the optimal solution where the demand dependency graph does not include the loop.

Here, the calculation model to implement the design (best design) in which no demand is cancelled is constructed by using constraint expressions (1) to (5), constraint expression (6) from which a term including “IsDisrupted(cd)” is removed, and the parameters corresponding to Nos. 1 to 8, 10, and 12 to 15 in FIG. 15. This calculation model becomes a basic model.

$$\begin{matrix}{\sum }_{cd ∈ h}^{ } RepUsedSlot ( cd , rd , h ) + NewUsedSlot ( rd , h ) = BW ( rd ) * IsHOODUUsed ( h , rd ) ( for ∀ rd , h ) . & ( 1 ) \\ {\sum }_{rd}^{ } RepUsedSlot ( cd , rd , h ) \leq BW ( cd ) * RemainHOODU ( h ) ( for ∀ cd , h ) . & ( 2 ) \\ NewUsedSlot ( rd , h ) \leq ( BW ( h ) - {\sum }_{cd ∈ h}^{ } BW ( cd ) ) * IsUsedHOODU ( h , rd ) ( for ∀ h ) . & ( 3 ) \\ - M * IsRepOccur ( cd , rd ) + {\sum }_{h}^{ } RepUsedSlot ( cd , rd , h ) ) \leq 0 ( for ∀ ( cd , rd ) except cd = rd ) & ( 4 ) \\ {\sum }_{h}^{ } IsUsedHOODU ( h , rd ) = 1 ( for ∀ hr , rd ) & ( 5 ) \\ - M * IsDisrupted ( cd ) - M * ( 1 - IsRepOccur ( cd , rd ) ) + ( AHC ( cd ) + IsRepOccur ( cd , rd ) \leq AHC ( rd ) ( for ∀ ( cd , rd ) except cd = rd ) & ( 6 )\end{matrix}$$

The calculation model to implement the design (second best design) in which the minimum number of demands are cancelled is constructed by using constraint expressions (1) to (5), constraint expression (6) (including the term which includes “IsDisrupted (cd)”), and the parameters corresponding to Nos. 1 to 10 and 12 to 15 in FIG. 15. At this time, the mathematical programming model construction unit 131a can construct the aforementioned calculation model by applying constraint expression (7) below to the demand that is not permitted to be cancelled among the demands D1 to D4, for each of which the allocation pattern is to be calculated.

IsDisrupte d(d)=*or Disrupt impossible d) (7)

Note that the network design apparatus 10 is an apparatus which re-optimizes the network N1 that is optimized once, and thus needs to correspond in a way different from constructing the aforementioned calculation model when the design result itself varies before and after the re-optimization. In such case, the mathematical programming model construction unit 131a uses constraint expressions (1) to (7), constraint expressions (8) and (9), and the parameters corresponding to Nos. 1 to 15 in FIG. 15 to construct the calculation model.

The aforementioned case corresponds to a case where the number of links used varies before and after the re-optimization. For example, in FIGS. 4A and 4B, the number of links used by the demands D1 to D4 before the re-optimization equals “6” (all six links), whereas the number of links used by the demands D1 to D4 after the re-optimization equals “3”. This means that the number of links used in the network N1 decreases as the network is re-optimized. Accordingly, the allocation pattern calculation unit 131b of the arithmetic unit 13 included in the network design apparatus 10 determines which of the links used before the re-optimization is diverted as the link used after the re-optimization when calculating the allocation pattern. FIGS. 4A and 4B illustrate the example where three links A-D, D-C, and D-E out of the six links used before the re-optimization are used (diverted) successively after the re-optimization.

$$\begin{matrix}{\sum }_{h ∈ hr , bw}^{ } RemainCHOODU ( h ) \leq TotalCHOODUNum ( hr , bw ) ( for ∀ hr , bw ) & ( 8 ) \\ {\sum }_{rd}^{ } BW ( rd ) * IsUsedHOODU ( h , rd ) - BW ( h ) * RemainCHOODU ( h ) \leq 0 ( for ∀ h ) & ( 9 )\end{matrix}$$

Referring back to FIG. 11, a demand change procedure extraction unit 132a determines the demand change procedure from the acquired demand dependency graph (refer to FIG. 9C) (S5) when the solution exists in the calculation result obtained in S3 (S4; Yes). That is, the demand change procedure extraction unit 132a assigns a change order to each of the demands D1 to D4 from the demand D3 in the lowermost stream in the demand dependency graph toward the upstream. Note that when the demand dependency graph includes the loop (refer to FIG. 10C), the demand change procedure extraction unit 132a assigns the change order from the demand D1 as a starting point toward the upstream, the demand D1 being the demand that can be cancelled in the loop. Thereafter, the slot to which each of the demands D1 to D4 is allocated is changed according to the assigned order.

When it is determined in S4 that the solution does not exist in the calculation result obtained in S3 (S4; No), the constraint easement feasibility determination unit 131c determines the presence of a fixed slot that can be freed (S6). When it is determined that there exists the fixed slot that can be freed (S6; Yes), the mathematical programming model construction unit 131a eases the constraint to fix the slot being used (S7) and re-executes the process from S3 onward.

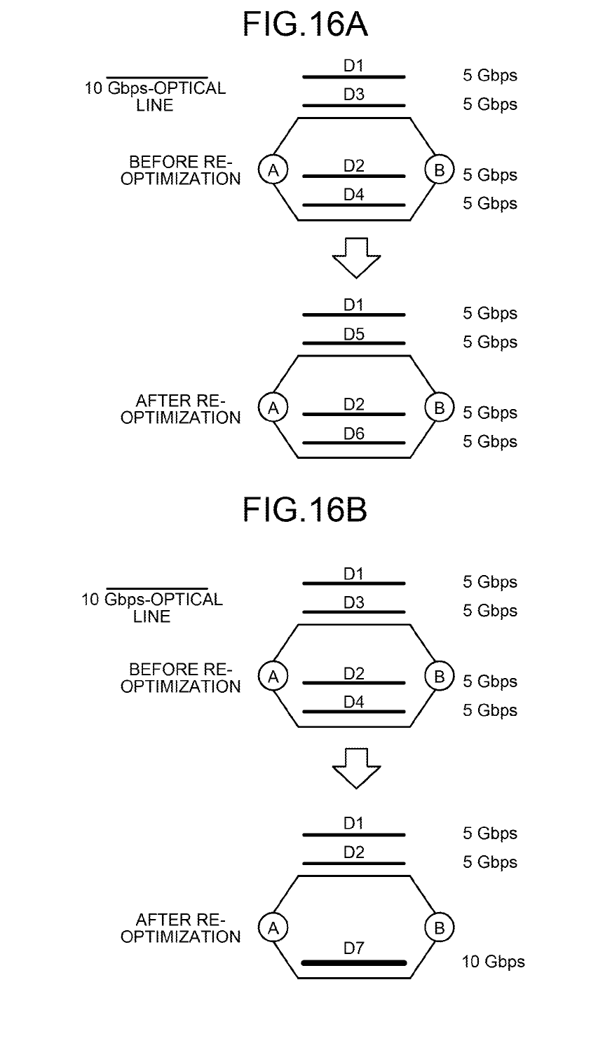

Now, a constraint easement process I (easement of constraint to fix the slot being used) will be described in more detail with reference to FIGS. 16A and 16B. FIG. 16A is a diagram illustrating the demand that does not require the process of easing the constraint to fix the slot being used. It is assumed in FIG. 16A that the demands D1 and D2 are under the fixing constraint which limits the slot being used where the demands D1 and D2 need to use the same 10-Gbps optical line before and after the re-optimization. In this case, in the example illustrated in FIG. 16A, the demands D1 and D2 use the same optical line before and after the re-optimization, whereby no problem arises in particular when the network design apparatus 10 keeps the slot fixed.

On the other hand, FIG. 16B is a diagram illustrating the demand that requires the process of easing the constraint which fixes the slot being used. FIG. 16B illustrates the example where one of the 10-Gbps optical lines is occupied by a 10-Gbps demand D7 after the re-optimization. This causes the solution by which the slot allocation can be executed to be nonexistent unless the network design apparatus 10 eases the constraint which fixes the slot being used and moves either one of the demands D1 and D2 used both before and after the re-optimization. The fixing constraint needs easement in such case.

It is however difficult to make a distinction whether or not the fixing constraint needs easement. Now, in executing the loop of S3 to S9 in FIG. 11, the network design apparatus 10 may implement the design to fix the slot being used in the first round of loop, so that the process always proceeds to S8 after completing the process in S6. The network design apparatus 10 may then ease the constraint which fixes the slot being used for the first time when the solution does not exist after the first round of loop (S4; No), so that the process in S7 can be executed after completing the process in S6. This also brings a benefit of improving the extensibility of the network N1.

The constraint easement feasibility determination unit 131c determines the presence of the demand that can be cancelled (S8) when it is determined in S6 that there is no fixed slot that can be freed (S6; No). When it is determined that there exists the demand that can be cancelled (S8; Yes), the mathematical programming model construction unit 131a eases a condition under which the demand can be cancelled (S9) and then re-executes the process from S3 onward.

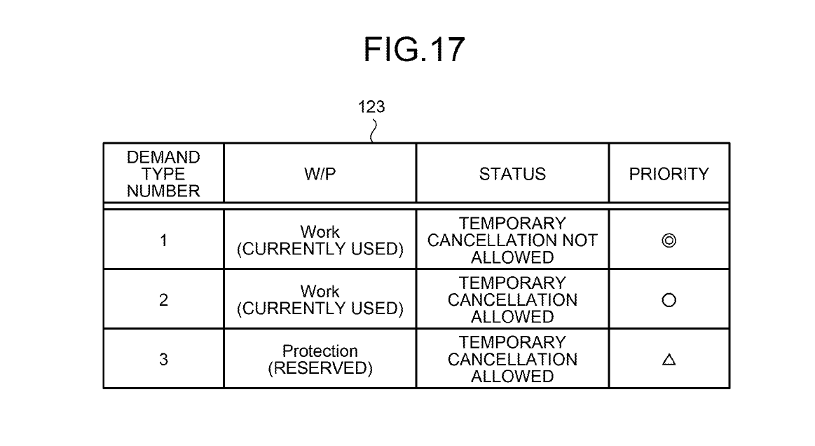

Now, a constraint easement process II (demand cancellation constraint easement) will be described in more detail with reference to FIG. 17. While the best design is the one that does not require any demand cancellations in the re-optimization, there is a case where the network design apparatus 10 is unable to realize the re-optimization unless the apparatus allows the demand to be cancelled, depending on the mode of the network N1 or the way the network is optimized. In such case where the condition under which the demand can be cancelled needs easement, the network design apparatus 10 can apply constraint expression (7) described above to implement the design in which the demand is cancelled in a variable manner according to the priority of the demand.

FIG. 17 is a diagram illustrating whether or not cancellation is possible according to a type of the demand. In a demand cancellation feasibility table 123 as illustrated in FIG. 17, for example, the demand to which “1” is assigned as a “type number” has a status “Work (currently used)” and “temporary cancellation not allowed”, whereby the highest rank “⊙” is set as “priority”. The demand to which “2” is assigned as the “type number” has a status “Work (currently used)” and “temporary cancellation allowed”, whereby an intermediate rank “◯” is set as the “priority”. Thus, a different value is set as the “status” of the demand according to the contract content established with a customer (such as a level of service level agreement) between the demands that are both in the same status “Work (currently used)”. Moreover, the demand to which “3” is assigned as the “type number” has a status “Protection (reserved)” and “temporary cancellation allowed”, whereby the lowest rank “Δ” is set as the “priority”.

The network design apparatus 10 can realize the design as follows, for example, by variably setting whether or not the cancellation is feasible according to the type of the demand. That is, in executing the loop of S3 to S9 in FIG. 11, the network design apparatus 10 implements the design to prohibit cancellation of all types of demands in the first round of loop. The network design apparatus 10 then allows only the demand to which “3” is assigned as the “type number” to be cancelled when the solution is not obtained in the first round of loop (S4; No). When the solution still is not obtained in the second round of loop (S4; No), the network design apparatus 10 further eases the condition under which the demand can be cancelled, and implements the design to allow the demand to which “2” is assigned as the “type number” to be cancelled in addition to the demand to which “3” is assigned.

The network design apparatus 10 determines that the designing of the network N1 has failed (S10) when it is determined in S8 that there is no demand that can be cancelled (S8; No). In particular, for example, it is effective to take the following measures when the solution still does not exist after performing the corresponding constraint easement by algorithm. That is, the network design apparatus 10 can take the measure of adding an optical line, changing the demand, re-executing the re-optimization design where the current designing result is now a prohibitive constraint, or increasing the lower limit of the number of demand cancellations.

Note that the two types of constraint easement processes described above are executed in an arbitrary order. In other words, the used slot fixing constraint easement process precedes the demand cancellation constraint easement process in FIG. 11, but the network design apparatus 10 may preferentially execute the latter instead.

The network design apparatus 10 as described above uses integer linear programming (ILP) to execute the process of constructing the slot allocation calculation model having the change procedure consideration function (S3 in FIG. 11). At the same time, the network design apparatus 10 executes the constraint easement process (S6 to S9 in FIG. 11) which can be implemented by utilizing the aforementioned model and gradually eases the design constraining condition when the solution does not exist. The network design apparatus 10 can realize the slot allocation design after the re-optimization and the designing of the change procedure which realizes the design content at the same time through each process described above.

Next, a process of outputting the method of re-optimizing the network N1 (the result of demand allocation to the slot and the demand change procedure) with reference to the network N1 illustrated in FIGS. 4A and 4B once again.

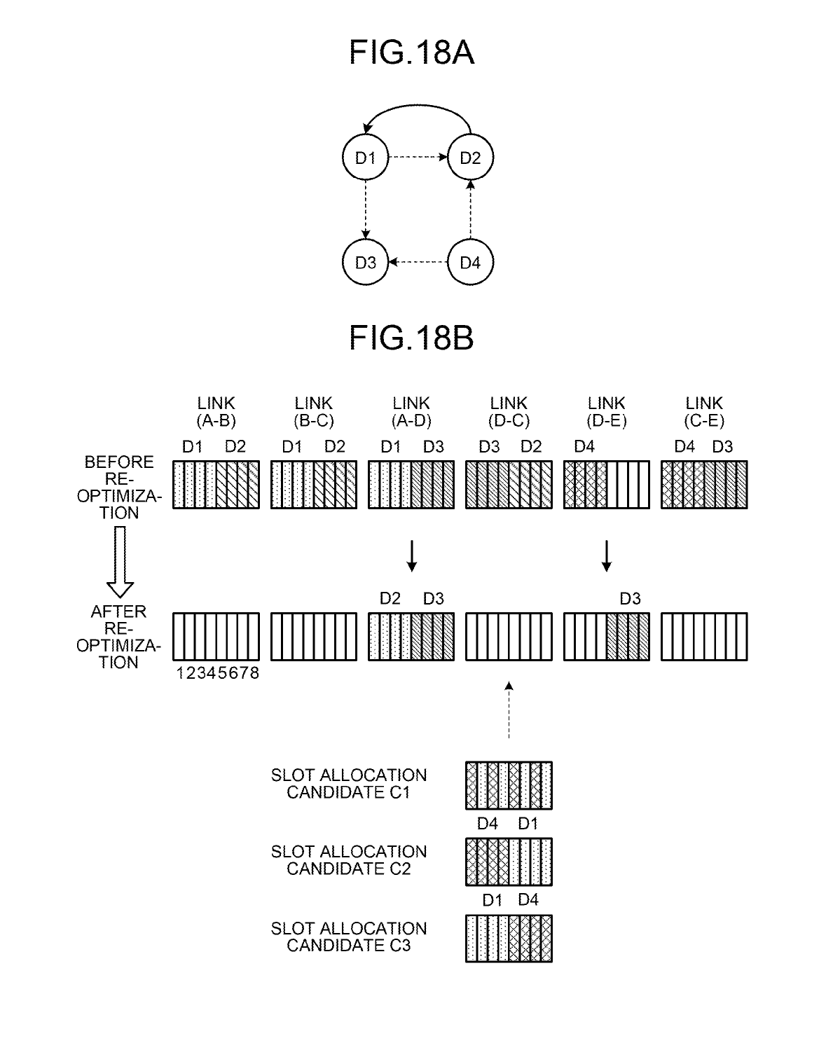

FIG. 18A is a diagram used to describe the number of demands involved in the slot allocation out of the total number of demands. While a total number of demands d within the network N1 illustrated in FIGS. 4A and 4B is “4”, the number of demands dₛₗₒₜ involved in the slot allocation is “2”, as illustrated in FIG. 18A. The detailed description will be provided below with reference to FIG. 18B.

FIG. 18B is a diagram used to describe the method of allocating the demand involved in the slot allocation. In the link A-D, the demand D3 is allocated both before and after the re-optimization and is thus allocated to the slot in a single pattern (slot numbers 5 to 8). As a result, the demand D2 is allocated to the link A-D in a single pattern (slot numbers 1 to 4). In the link D-E, slots numbered 1 to 4 are used by the demand D4 before the re-optimization so that the demand D3 is determined to be allocated to vacant slots (slot numbers 5 to 8) excluding the slot numbers 1 to 4.

In the link D-C, on the other hand, the demands D1 and D4 are newly allocated to vacant slots (slot numbers 1 to 8) after the demands D3 and D2 allocated thereto before the re-optimization are deleted. Therefore, the method of allocating the demands D1 and D4 is not uniquely specified but includes at least three patterns such as slot allocation candidates C1 to C3 illustrated in FIG. 18B. That is, only the demands D1 and D4 are involved in the slot allocation out of all the demands D1 to D4 from which the demands D2 and D3 are excluded. The number of demands dₛₗₒₜ involved in the slot allocation equals “2” as a result.

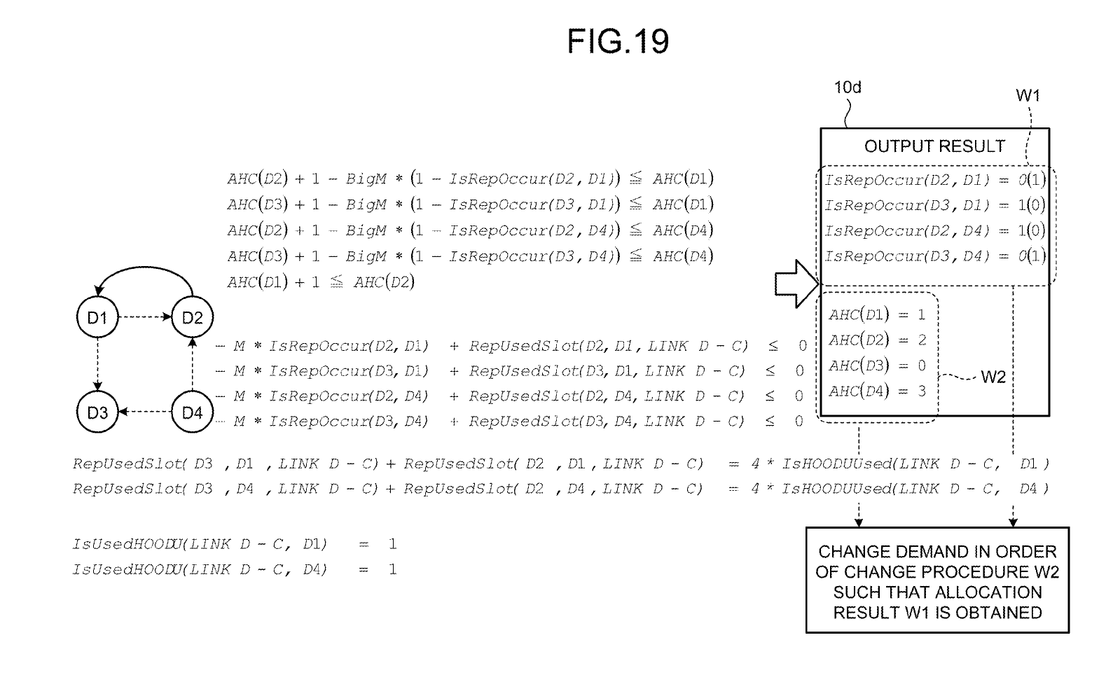

The network design apparatus in the related art does not consider the change procedure when executing the slot allocation and therefore tests one by one a slot allocation pattern which possibly has a solution. Accordingly, it is difficult to specify the change procedure which does not result in the deadlock in the first attempt, meaning that the network design apparatus needs to perform the calculation for a plurality of times until the apparatus derives the design that can be re-optimized without cancelling the demand. On the other hand, the network design apparatus 10 according to the present embodiment can derive the network design that can be re-optimized by single calculation. A method of deriving the output result will be described in detail with reference to FIG. 19.

FIG. 19 is a diagram illustrating how an optimal solution for the demand change can be obtained by the single calculation. As illustrated in FIG. 19, the network design apparatus 10 uses constraint expressions (6), (4), (1), and (5) to calculate a demand allocation result to the slot (slot allocation result) W1 and a demand change procedure W2 based on a condition input by the user, and outputs the calculated results to the display device 10d as a final output result. The user of the network design apparatus 10 can promptly and accurately grasp the optimal solution for the demand change by referring to the output result.

Note that as described above, the link D-C is the only link that has the plurality of slot allocation candidates in the example illustrated in FIG. 19, so that constraint expression (2) is self-evident. Accordingly, constraint expression (2) will be omitted. Moreover, there is not a new link (HO-ODU: High Order channel-Optical Data Unit) in the example illustrated in FIG. 19 so that constraint expression (3) has “0” on both sides. Accordingly, constraint expression (3) will be omitted.

The network design apparatus 10 includes the allocation pattern calculation unit 131b, the demand change procedure extraction unit 132a, and the output unit 14 as described above. The allocation pattern calculation unit 131b calculates, from among the plurality of allocation candidates, the allocation pattern (the best design in FIG. 6A) that does not require cancellation of the demands D1 to D4 when allocating the demands D1 to D4 transmitted/received among the nodes A to E on the network N1 to the slot configuring the link on the network N1. The demand change procedure extraction unit 132a determines the change procedure of each of the demands D1 to D4 (refer to FIG. 6B) employed to change the allocation pattern of the network N1 before the re-optimization to the allocation pattern calculated by the allocation pattern calculation unit 131b. The output unit 14 outputs the allocation pattern calculated by the allocation pattern calculation unit 131b as the allocation pattern of the network N1 after the re-optimization along with the change procedure determined by the demand change procedure extraction unit 132a.

That is, the network design apparatus 10 considers the order of changing each of the demands D1 to D4 when changing the pattern of allocating the demands D1 to D4 to each slot in order to re-optimize the network N1. The network design apparatus 10 can therefore re-optimize the network N1 while keeping down the number of cancellations of the demand allocated to the slot.

Moreover, the allocation pattern calculation unit 131b of the network design apparatus 10 may calculate the allocation pattern which has the minimum number of cancellations of the demands D1 to D4 (the second best design in FIG. 7A) when there is no allocation pattern that does not require cancellation of the demands D1 to D4. The allocation pattern calculation unit 131b may also determine which of the links before the re-optimization is diverted as the link after the re-optimization when the demands D1 to D4 use different links before and after re-optimizing the network N1.

The network design apparatus 10 may further include the constraint easement feasibility determination unit 131c which performs the control to ease the constraint to fix the slot used by each of the demands D1 to D4 or the condition under which each of the demands D1 to D4 can be cancelled, when there is no allocation pattern that does not require cancellation of the demands D1 to D4 (S4; No).

The network design apparatus 10 may further include the mathematical programming model construction unit 131a which classifies the plurality of optical line links M1 and M2 corresponding to the same physical link T1 into the same group prior to calculating the allocation pattern. In this case, the constraint easement feasibility determination unit 131c may add the fixing constraint to the slot used by the same demand (such as D3) before and after the re-optimization, from among the plurality of slots included in the plurality of optical line links M1 and M2 classified into the same group by the mathematical programming model construction unit 131a. In other words, the constraint easement feasibility determination unit 131c may add the constraint to fix the aforementioned slot (such as the slot having the slot numbers 5 to 8 of the link A-D in FIG. 6A) as the slot used by the aforementioned demand (the slot used exclusively by the aforementioned slot).

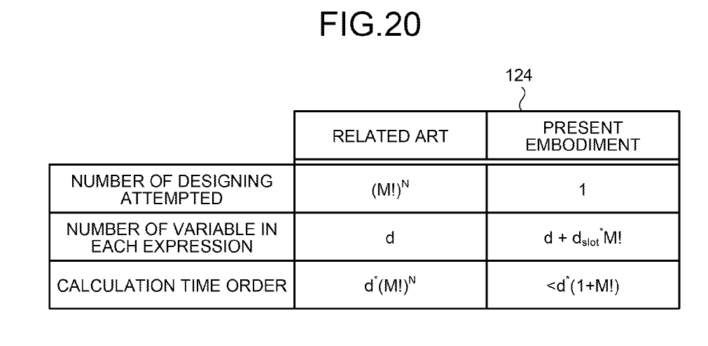

Now, the effect attained by the network design apparatus 10 according to the present embodiment will be described in more detail with reference to FIGS. 20, 18A, and 18B and the network configuration illustrated in FIGS. 4A and 4B as the example.

In a case where there are 72 nodes, 86 links and 60 demands, for example, the optimality of the design result improves twofold or more compared to the method in the related art where the calculation time is the same. That is, even when the change procedure without demand cancellation cannot be presented in the method of the related art, there exists a case where such procedure can be presented according to the network design apparatus 10 of the present embodiment. Moreover, there exists a case where the number of demand cancellations can be decreased as compared to the method in the related art even when the network design apparatus 10 according to the present embodiment cannot present the change procedure without demand cancellation.

The network design apparatus 10 can also obtain the effect of reducing the calculation load by considering the change procedure with use of the mathematical programming. FIG. 20 is a diagram used to describe the effect of reducing the calculation load accompanying the calculation of the allocation result and the change procedure. As the assumption to the description, “N” denotes the number of links involved in the slot allocation, “M” denotes the number of types of the demand before the re-optimization involved in the slot allocation, and the “dₛₗₒₜ” denotes the number of demands involved in the slot allocation as described above. The number of slot allocation candidates per link is represented by M! (factorial of M) with use of the “M”.

While the total number of links equals “6” in the example illustrated in FIGS. 4A and 4B, the link D-C is the only link involved in the slot allocation as described above. N=1 is set as a result. Where the demands D3 and D2 are of different types (refer to FIG. 17), the number of types of the demand involved in the slot allocation before the re-optimization is two being the demands D3 and D2 (refer to FIG. 18B). M=2 is set as a result. Likewise, the demands D1 and D4 are involved in the slot allocation in FIG. 18B, where dₛₗₒₜ=2 is set as the number of demands dₛₗₒₜ. M!=2 is further set as the number of slot allocation candidates M! per link since M=2 is set.

Under the aforementioned condition, as illustrated in a calculation time comparison table 124 in FIG. 20, the number of designing attempted is decreased to one time compared to (M!)^{N}(2¹=2) times in the related art. The number of variables constructing each expression is changed from d to d+dₛₗₒₜ×M!. Furthermore, the calculation time is changed from d×(M!)^{N} to d×(1+M!) at the longest. While there is no big difference in the calculation times in the present embodiment where a simple network configuration is illustrated for the convenience of description, each of the number of nodes, the number of links, and the number of demands on a single network usually takes a large value such as approximately 50 to 100. Therefore, in calculating the allocation result of the demand to the slot, the network design apparatus 10 considers the change procedure by using the mathematical programming in order to be able to shorten the calculation time that has been in the order of N-th power (where N is a natural number) down to the order of N-fold.

Note that while a ring type is illustrated in FIG. 1 as the form of the network N1 according to the aforementioned embodiment, the present invention can also be applied to any form of network such as a bus type, a star type, a tree type, or a type combining these types. The number of nodes relaying a packet in the network is not limited to seven either.

Furthermore, each component of the network design apparatus 10 in the aforementioned embodiment does not necessarily have to be physically configured as illustrated in the figures. That is, the specific mode of breakup or integration of each device is not limited to what is illustrated in the figures, where all or a part of each device can be functionally or physically broken up or integrated by an arbitrary unit according to a variety of loads or use conditions. The input information storage unit 121 and the constraint easement information storage unit 122, or the mathematical programming model construction unit 131a, allocation pattern calculation unit 131b, and constraint easement feasibility determination unit 131c may each be integrated as a single component, for example. In contrast, the constraint easement feasibility determination unit 131c may be broken up into a part which determines whether or not the constraint easement process can be applied and a part which updates information in the constraint easement information storage unit 122. Furthermore, a memory which stores the input information and the constraint easement information may be connected to the network design apparatus 10 as an external device thereof through a network or a cable.

According to the embodiments, the network can be re-optimized while suppressing the number of cancellations of the demand allocated to the slot.

All examples and conditional language provided herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A network design apparatus comprising:
a memory; and
a processor coupled to the memory, wherein the processor executes a process including:
calculating an allocation pattern not requiring cancellation of a connection request from among a plurality of allocation candidates, when the connection request transmitted/received between nodes on a network is to be allocated to a slot that constructs a link on the network;
determining a change procedure of the connection request in order to change an allocation pattern provided before the network is re-optimized to the allocation pattern calculated at the calculating; and
outputting the allocation pattern calculated at the calculating as an allocation pattern after the network is re-optimized, along with the change procedure determined at the determining.

2. The network design apparatus according to claim 1, wherein the calculating includes calculating an allocation pattern which results in the minimum number of cancellations of the connection request when the allocation pattern not requiring cancellation of the connection request does not exist.

3. The network design apparatus according to claim 1, wherein the calculating includes determining which of links used before the re-optimization is diverted as a link used after the re-optimization when the connection request uses a different link before and after the network is re-optimized.

4. The network design apparatus according to claim 1, further including performing control to ease a fixing constraint for a slot used by the connection request or a condition under which the connection request is cancelable, when the allocation pattern not requiring cancellation of the connection request does not exist.

5. The network design apparatus according to claim 4, further including classifying a plurality of links corresponding to the same physical link into the same group prior to calculating the allocation pattern, wherein
the performing includes adding the fixing constraint to a slot, which is used by the same connection request before and after the re-optimization, from among a plurality of slots constructing the plurality of links classified into the same group at the classifying.

6. A network design method comprising:
in a network design apparatus,
calculating an allocation pattern not requiring cancellation of a connection request from among a plurality of allocation candidates, when the connection request transmitted/received between nodes on a network is to be allocated to a slot that constructs a link on the network, using a processor;
determining a change procedure of the connection request in order to change an allocation pattern provided before the network is re-optimized to the calculated allocation pattern, using the processor; and
outputting the calculated allocation pattern as an allocation pattern after the network is re-optimized, along with the determined change procedure, using the processor.
